(19) United States
(12) Patent Application Publication
(10) Pub. No.: US 2026/0031430 A1
(43) Pub. Date: Jan. 29, 2026

(54) BATTERY STORAGE CASE

(71) Applicant: HONDA MOTOR CO., LTD., Tokyo (JP)

(72) Inventors: Masaaki Tatsuwaki, Wako-shi (JP); Ken Yasui, Wako-shi (JP)

(21) Appl. No.: 19/277,465

(22) Filed: Jul. 23, 2025

(30) Foreign Application Priority Data
Jul. 29, 2024 (JP) 2024-122321

(51) Int. Cl. H01M 10/656; B60R 16/04; H01M 10/613; H01M 10/625

(52) U.S. Cl. CPC H01M 10/656; H01M 10/613; H01M 10/625; B60R 16/04; H01M 2220/20

(57) ABSTRACT

This battery storage case includes a bottom wall member having a module placement portion on which a battery module is placed and having a coolant passage built thereinto, an outer frame connected to an outer edge of the bottom wall member, and an adapter part connected to the coolant passage and configured to supply and discharge a coolant to and from the coolant passage. The outer frame has an upper upright portion configured to rise upward from an upper surface of the bottom wall member and an inclined block portion connected to a side surface of the upper upright portion and configured to bulge downward from an upper portion so that a distance from the upper upright portion increases and have a lower surface in contact with the bottom wall member. A through hole which passes therethrough in an up-down direction and to which the adapter part is connected on an upper portion side is provided on the inclined block portion. A joint part having one end connected to the coolant passage and the other end on which a connection tube is formed is attached in a region where the upper upright portion of the bottom wall member and the inclined block portion are placed. The connection tube protrudes obliquely upward from the bottom wall member toward the upper surface of the inclined block portion inside the through hole. The adapter part is connected to the connection tube of the joint part in a fitted state inside the through hole.

### CROSS-REFERENCE TO RELATED APPLICATION

The present application claims priority based on Japanese Patent Application No. 2024-122321, filed Jul. 29, 2024, the content of which is incorporated herein by reference.

### BACKGROUND OF THE INVENTION

### Field of the Invention

The present invention relates to a battery storage case storing battery modules.

### Description of Related Art

As a battery storage case storing a battery module (a module in which a plurality of battery cells are stacked), a battery storage case for cooling with respect to heat generated by the battery cells using a coolant is known (for example, see Published Japanese Translation No. 2013-525947 of the PCT International Publication).

The battery storage case described in Published Japanese Translation No. 2013-525947 of the PCT International Publication is configured to store the plurality of battery cells in a sealed case body and to allow a coolant to flow inside the case body. An inlet port for introducing the coolant from the outside and an outlet port for discharging the coolant to the outside after cooling is completed are provided in the case body.

### SUMMARY OF THE INVENTION

The battery storage case described in Published Japanese Translation No. 2013-525947 of the PCT International Publication has a structure in which the outer side of a plurality of battery cells is covered in a sealed state by a case body and a coolant is circulated around the stacked battery cells. Therefore, the cooling performance for the battery cells is suitable in the case of this battery storage case, but a volume of the case body is increased and the overall weight is also increased.

As a countermeasure to this problem, a configuration in which a case body of the battery storage case includes a bottom wall member on which the battery module is placed and an outer frame connected to an edge of the bottom wall member and a coolant passage is provided inside the bottom wall member has been considered.

In this case, the coolant passage is formed inside the bottom wall member so that the coolant flows approximately horizontally. Although it is necessary to connect this coolant passage to an external coolant circulation circuit, it is necessary to arrange a supply/discharge passage connecting the coolant passage and the circulation circuit over the outer frame. In this case, the supply/discharge passage connected to the coolant passage within the bottom wall member is bent and piped in a crank shape, but the pressure loss of the coolant flowing through a flow path increases if the piping is bent in the crank shape.

At present, it is considered that a solution to this problem is to connect the supply/discharge passage to the coolant passage within the bottom wall member in an obliquely inclined state.

However, when an attempt is made to obliquely install the supply/discharge passage while avoiding an increase in the size of the battery case, this solution means that the supply/discharge passage passes through the outer frame, which is likely to reduce the rigidity of the outer frame.

An aspect of the present invention is to provide a battery storage case that can reduce the pressure loss of the coolant supplied to and discharged from a coolant passage while suppressing a decrease in the rigidity of an outer frame. Also, the present invention contributes to energy efficiency by reducing power loss and making the entire battery storage case smaller and lighter.

In order to achieve the above-described objective, a battery storage case according to an aspect of the present invention employs the following configurations.
(1) According to an aspect of the present invention, there is provided a battery storage case including: a bottom wall member (e.g., a bottom wall member 13 of the embodiment) having a module placement portion (e.g. a module placement portion 19 of the embodiment) on which a battery module (e.g., a battery module 7 of the embodiment) is placed and having a coolant passage (e.g., a coolant passage 14 of the embodiment) built thereinto; an outer frame (e.g., an outer frame 32 of the embodiment) connected to an outer edge of the bottom wall member; and an adapter part (e.g., an adapter part 40 of the embodiment) connected to the coolant passage and configured to supply and discharge a coolant to and from the coolant passage, wherein the outer frame has an upper upright portion (e.g., an upper upright portion 20 of the embodiment) configured to rise upward from an upper surface of the bottom wall member; and an inclined block portion (e.g., an inclined block portion 21 of the embodiment) connected to a side surface of the upper upright portion and configured to bulge downward from an upper portion so that a distance from the upper upright portion increases and have a lower surface in contact with the bottom wall member, wherein a through hole (e.g., a through hole 22 of the embodiment) which passes therethrough in an up-down direction and to which the adapter part is connected on an upper portion side is provided on the inclined block portion, wherein a joint part (e.g., a joint part 33 of the embodiment) having one end connected to the coolant passage and the other end on which a connection tube (e.g., a connection tube 33b of the embodiment) is formed is attached in a region where the upper upright portion of the bottom wall member and the inclined block portion are placed, wherein the connection tube protrudes obliquely upward from the bottom wall member toward the upper surface of the inclined block portion inside the through hole, and wherein the adapter part is connected to the connection tube of the joint part in a fitted state inside the through hole.

According to the above-described aspect (1), the coolant is supplied to and discharged from the coolant passage of the bottom wall member via the joint part and the adapter part. Although the through hole in which the adapter part and the joint part are arranged in a connected state is formed in the outer frame, this through hole is mainly formed in the inclined block portion connected to the upper upright portion of the outer frame. Therefore, the through hole does not significantly reduce the rigidity of the outer frame. Moreover, the inclined block portion is connected to the upper upright portion of the outer frame, and its lower surface is in contact with the upper surface of the outer edge of the bottom wall member. Therefore, the inclined block portion is supported with high rigidity by the upper upright portion and the bottom wall member. Therefore, in this configuration, even if the through hole is formed in the outer frame, the rigidity of the outer frame can be maintained at a high level.

Moreover, because the connection tube of the joint part protrudes obliquely upward inside the through hole, the coolant supplied to and discharged from the coolant passage of the bottom wall member flows through the passage (the connection tube) that is obliquely inclined at an obtuse angle. Thus, the pressure loss of the coolant is reduced compared to when the coolant is supplied to and discharged from the coolant passage through a passage that is bent at approximately a right angle. Therefore, when this configuration is employed, the energy loss can be suppressed when the coolant flows through the coolant passage.

Moreover, the joint part having the connection tube is attached to the bottom wall member, and the adapter part is connected to the connection tube of the joint part in a fitted state inside the through hole. Therefore, when the outer frame is assembled to the bottom wall member, the adapter part is attached in advance to the through hole of the outer frame, and in this state, the adapter part can be fitted into the connection tube of the joint part on the bottom wall member side, thereby aligning the outer frame with the bottom wall member. Therefore, when this configuration is employed, the assembling work of the outer frame to the bottom wall member can be easily performed.
(2) In the above-described aspect (1), the outer frame may include a first frame (e.g., a first cross member 12f of the embodiment) having the upper upright portion and the inclined block portion and extending in a vertical direction and a first direction; and a pair of second frames (e.g., a main frame member 11 of the embodiment) extending in a second direction intersecting the first direction and the vertical direction and connected to both ends of the first frame in an extending direction, and the end of the first frame in the extending direction may be connected to the upper upright portion at a position on an inward side of an end of the second frame in the extending direction.

According to the above-described aspect (2), because the first frame having the inclined block portion is connected to the upper upright portion at a position on the inward side of the end of the second frame in the extending direction, when an impact load is input from the side of the second frame, the load is reliably absorbed by the first frame at the position on the inward side of the end of the second frame in the extending direction. At this time, because the first frame is connected to the second frame at the upper upright portion, the inclined block portion is located at a position away from the load transmission path of the upper upright portion. Therefore, the impact load is less likely to be input to the inclined block portion. Therefore, when this configuration is employed, the impact load is less likely to be transmitted around the supply/discharge portion of the coolant passage.
(3) In the above-described aspect (1), the upper upright portion may extend in a direction intersecting a vertical direction, and the inclined block portion may be connected to only a part of the upper upright portion in an extending direction.

According to the above-described aspect (3), because the inclined block portion bulging out from the side of the upper upright portion is connected to only a part of the upper upright portion in the extending direction, it is possible to supply and discharge the coolant to and from the coolant passage of the bottom wall member as desired while avoiding the outer frame becoming larger and heavier.
(4) In the above-described aspect (1), the upper upright portion and the inclined block portion may be formed as a single molded part.

According to the above-described aspect (4), the upper upright portion and the inclined block portion can be easily formed and the overall rigidity and strength can be maintained at a higher level.
(5) In the above-described aspect (1), the joint part may include an inlet-side joint part (e.g., an inlet-side joint part 33i of the embodiment) connected to an inlet of the coolant of the coolant passage and an outlet-side joint part (e.g., an outlet-side joint part 33o of the embodiment) connected to an outlet of the coolant of the coolant passage, the inlet-side joint part and the outlet-side joint part may be attached mutually adjacent to the bottom wall member, the through hole into which the connection tube of each of the inlet-side joint part and the outlet-side joint part is inserted may be partitioned by a reinforcing rib (e.g., a reinforcing rib 23 of the embodiment) extending inside the outer frame in the up-down direction, and a lower end of the reinforcing rib may be in contact with the bottom wall member.

According to the above aspect (5), because the inner side of the through hole of the outer frame is reinforced by the reinforcing rib in a partitioned state, the rigidity in the vicinity of the through hole of the outer frame can be efficiently increased by the reinforcing rib. Moreover, because the reinforcing rib extends in the up-down direction inside the outer frame and has its lower end in contact with the bottom wall member, the heat of the battery module transmitted to the bottom wall member can be efficiently discharged to the outside through the reinforcing rib. Therefore, when this configuration is employed, it is possible to further increase the rigidity in the vicinity of the through hole of the outer frame and further increase the heat dissipation of the battery module.

According to the aspect of the present invention, it is possible to reduce the pressure loss of a coolant supplied to and discharged from a coolant passage while suppressing a decrease in the rigidity of an outer frame.

### BRIEF DESCRIPTION OF THE DRAWINGS

FIG. 1 is a cross-sectional view showing a structure of a vehicle underbody of a vehicle according to an embodiment.

FIG. 2 is a perspective view of a battery storage case according to the embodiment.

FIG. 3 is an exploded perspective view of the battery storage case according to the embodiment.

FIG. 4 is an enlarged view of a portion IV in FIG. 3 of the battery storage case according to the embodiment.

FIG. 5 is a cross-sectional view of the battery storage case according to the embodiment along line V-V in FIG. 4.

FIG. 6 is a bottom view of a portion of the battery storage case of the embodiment with a bottom wall member removed.

### DESCRIPTION OF EMBODIMENTS

Embodiments of the present invention will be described with reference to the drawings. In addition, in the appropriate places of the drawings, an arrow FR pointing to the front of a vehicle 1, an arrow UP pointing to the upward side of the vehicle 1, and an arrow LH pointing to the left side of the vehicle 1 are shown.

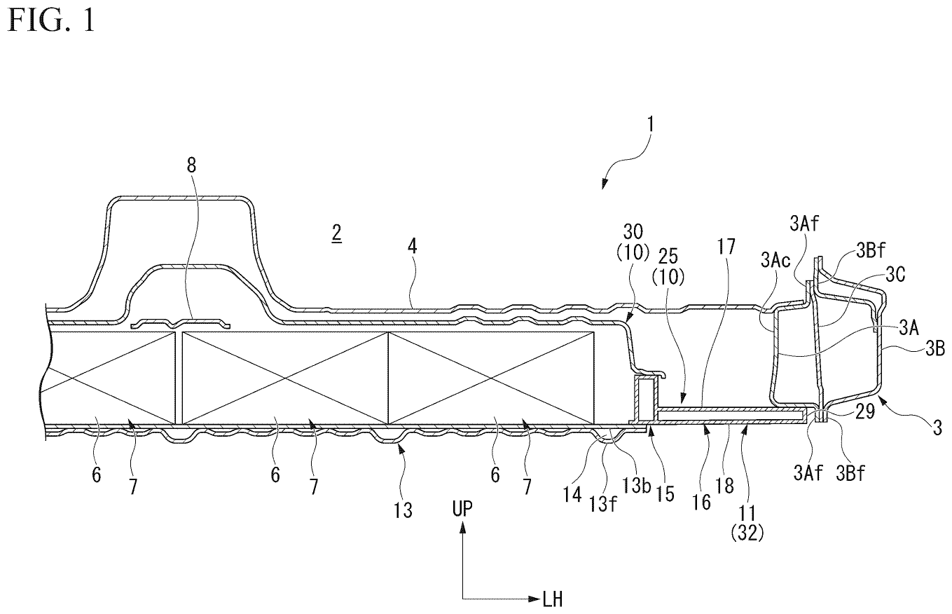

FIG. 1 is a diagram showing a vehicle underbody structure of the vehicle 1. FIG. 1 is a cross-sectional view of the underbody of the vehicle 1 cut in a direction perpendicular to a front-rear direction of a vehicle body.

A pair of side sills 3, which are frame members of the vehicle body extending approximately in the front-rear direction of the vehicle body, are arranged at lower positions on both sides of a vehicle cabin 2 in the vehicle width direction. Only one of the side sills 3 is shown in FIG. 1. A floor panel 4 is installed on the left and right side sills 3. A battery storage case 10 is arranged below the floor panel 4 to approximately follow the lower surface of the floor panel 4. The battery storage case 10 includes a case body 25 in which a plurality of battery modules 7 (battery cells 6), a control device (not shown), and the like are mounted on the upper surface side, and a cover member 30 that covers the upper part of the case body 25.

The case body 25 is formed in an approximately rectangular shape when seen from above. The left and right side edges of the case body 25 are fixed to the lower surfaces of the corresponding left and right side sills 3 by fastening members (not shown).

The side sill 3 is configured by sandwiching a stiffener 3C between a side sill inner 3A and a side sill outer 3B, each of which has a hat-shaped cross section. The side sill inner 3A and the side sill outer 3B have upper and lower joining flanges 3Af and 3Bf. The upper and lower joining flanges 3Af and 3Bf of the side sill inner 3A and the side sill outer 3B are arranged opposite each other. The joining flanges 3Af and 3Bf opposite each other are connected by welding or the like with the stiffener 3C sandwiched therebetween.

The side sill inner 3A has an inner bulge 3Ac having a U-shaped cross section that bulges to the inward side in the vehicle width direction from the bases of the upper and lower joining flanges 3Af and 3Bf. The left and right side edges of the case body 25 are connected to a lower surface of the inner bulge 3Ac of the side sill inner 3A.

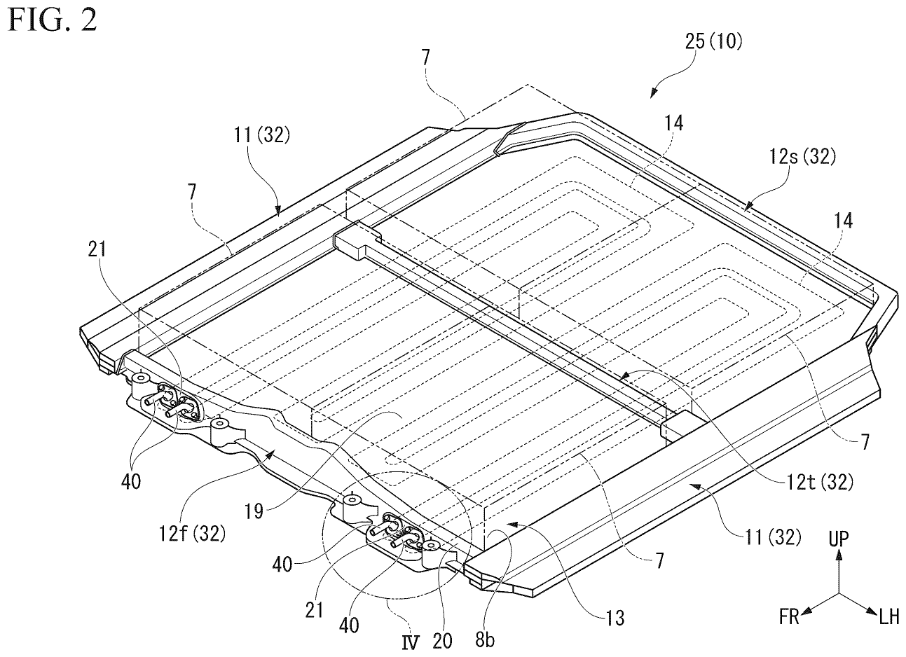

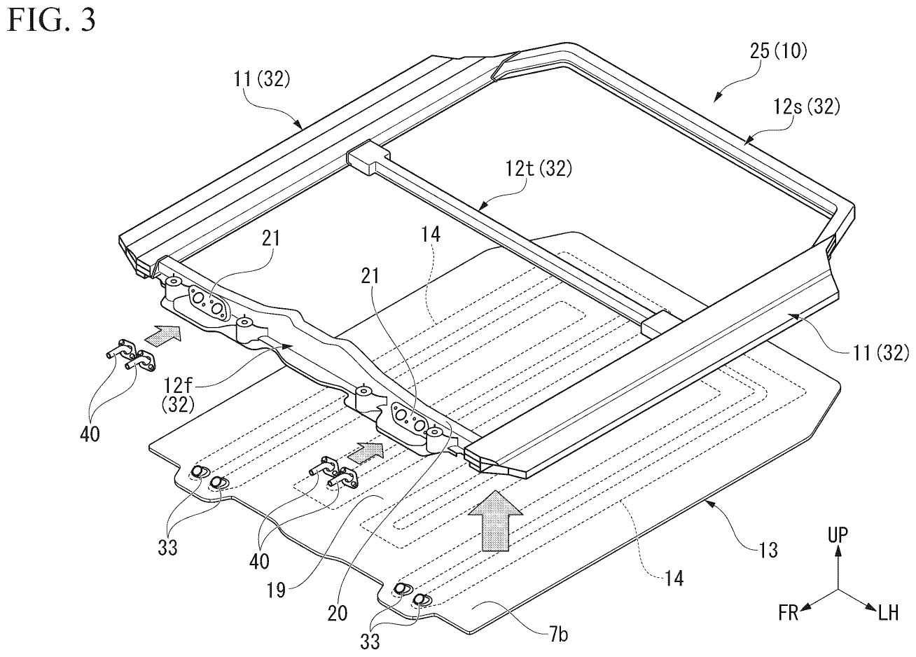

FIG. 2 is a perspective view of the battery storage case 10 and FIG. 3 is an exploded perspective view of the battery storage case 10. In addition, the cover member 30 is omitted in FIGS. 2 and 3.

The case body 25 of the battery storage case 10 includes a pair of main frame members 11 extending approximately in the front-rear direction of the vehicle body. The pair of main frame members 11 are arranged apart from each other in the vehicle width direction. The pair of main frame members 11 are connected by a first cross member 12f, a second cross member 12s, and a third cross member 12t extending in the vehicle width direction. The first cross member 12f has both ends connected in the vicinity of the front ends of the left and right main frame members 11 in the extending direction and the second cross member 12s has both ends connected in the vicinity of the rear ends of the left and right main frame members 11 in the extending direction. Moreover, the third cross member 12t has both ends in the extending direction connected at approximately a central position of the left and right main frame members 11 in the front-rear direction.

In the present embodiment, the vehicle width direction is a first direction intersecting with the vertical direction and the front-rear direction of the vehicle body is a second direction intersecting the first direction and the vertical direction. The pair of main frame members 11 extend in the second direction (the front-rear direction of the vehicle body) and are arranged apart from each other in the first direction (the vehicle width direction). The first, second, and third cross members 12f, 12s, and 12t extend in the first direction (the vehicle width direction) and have both ends connected to each main frame member 11 in the extending direction. The first cross member 12f constitutes a first frame extending in the first direction and the main frame member 11 constitutes a second frame extending in the second direction. Moreover, in the present embodiment, the pair of main frame members 11, the first cross member 12f, and the second cross member 12s constitute an outer frame 32.

The case body 25 further includes a bottom wall member 13 covering a lower space between the pair of main frame members 11. The bottom wall member 13 is formed in a rectangular shape when seen from above and the pair of main frame members 11 and the lower ends of the first, second, and third cross members 12f, 12s, and 12t are coupled to the upper surface side of the bottom wall member 13. A plurality (four) of battery modules 7 are placed on the upper surface side of the bottom wall member 13. Two battery modules 7 are placed side by side in the vehicle width direction on the front upper surface of the bottom wall member 13 in a state in which the third cross member 12t is sandwiched therebetween and the remaining two battery modules 7 are similarly placed side by side in the vehicle width direction on the rear upper surface of the bottom wall member 13 in a state in which the third cross member 12t is sandwiched therebetween. The outer circumference of the battery modules 7 (a plurality of battery cells 6) stored in the case body 25 is surrounded by the pair of main frame members 11 and the first, second, and third cross members 12f, 12s, and 12t.

Each battery module 7 stored in the case body 25 is arranged apart from the adjacent main frame member 11 so that contact with the adjacent main frame member 11 is not made. In other words, a space is provided between the left or right main frame member 11 and the adjacent battery module 7. In the present embodiment, the upper surface of the central region of the bottom wall member 13 serves as a module placement portion 19 on which the battery modules 7 are placed.

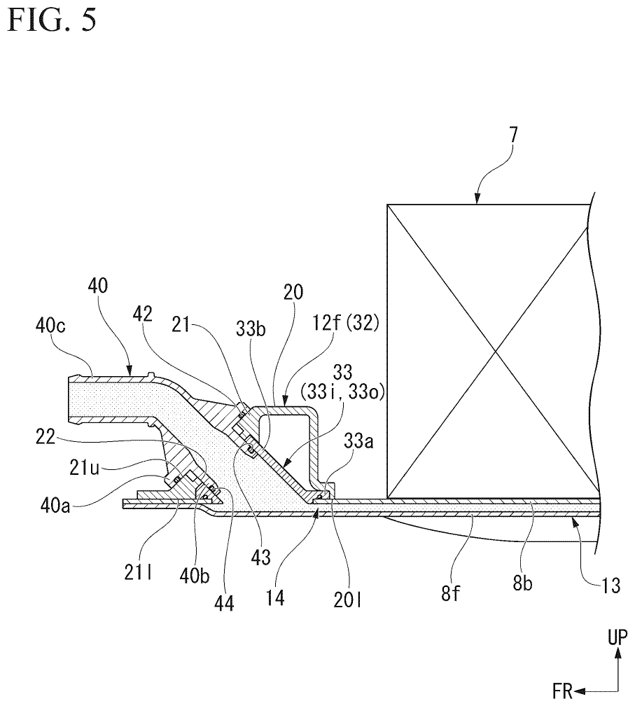

The bottom wall member 13 includes a base wall 8b facing a storage portion of the battery module 7 and a flow path forming wall 8f (see FIG. 5) joined to the lower surface side of the base wall 8b. The flow path forming wall 8f forms a coolant passage 14 for allowing the coolant to internally flow with the lower surface of the base wall 8b. The plurality of battery modules 7 stored in the battery storage case 10 are cooled by the coolant flowing through the coolant passage 14. In the present embodiment, one coolant passage 14 is provided for each of the left half and right half of the case body 25. Each coolant passage 14 is formed inside the bottom wall member 13 so that the coolant flows in a meandering manner in a horizontal direction. The bottom wall member 13 is configured as a multi-wall structure internally having a hollow portion according to the base wall 8b and the flow path forming wall 8f below the base wall 8b. The bottom wall member 13 maintains high rigidity due to this multi-wall structure.

Each battery module 7 has a plurality of battery cells 6 stored in a stacked state within a unit cover that is a rectangular parallelepiped with a narrow width in an up-down direction. A predetermined number of battery cells 6 are grouped together as the battery module 7 and stored within the battery storage case 10.

The number of battery modules 7 stored in the battery storage case 10 is not limited to four and any number can be selected in accordance with a size of the battery storage case 10, a layout of mounted parts, or the like.

As shown in FIG. 1, the main frame member 11 has a hollow base frame portion 15 to which extension ends of the first, second, and third cross members 12f, 12s, and 12t are connected to a surface on the inward side in the vehicle width direction and a hollow mounting frame portion 16 extending toward the outward side in the vehicle width direction from the end of the base frame portion 15 on the outward side in the vehicle width direction.

In the base frame portion 15, a cross section perpendicular to the front-rear direction of the vehicle body is formed on a closed cross section of a vertical rectangular shape. The closed cross section of the rectangle shape of the base frame portion 15 extends in approximately the front-rear direction of the vehicle body.

The mounting frame portion 16 has an upper wall portion 17 whose end on the inward side in the vehicle width direction is connected to the base frame portion 15 at approximately a central position in the height direction and a lower wall portion 18 whose end on the inward side in the vehicle width direction is connected to a lower end of the base frame portion 15. The lower wall portion 18 is arranged at a height position approximately equal to that of the bottom wall member 13. The ends of the upper wall portion 17 and the lower wall portion 18 on the outward side in the vehicle width direction are closed by end walls 29 that rise upward in approximately the vertical direction.

The mounting frame portion 16 has a horizontally elongated, approximately rectangular, closed cross section formed by the side wall of the base frame portion 15 on the outward side in the vehicle width direction, an upper wall portion 17, a lower wall portion 18, and an end wall 29. This closed cross section extends in the front-rear direction of the vehicle body.

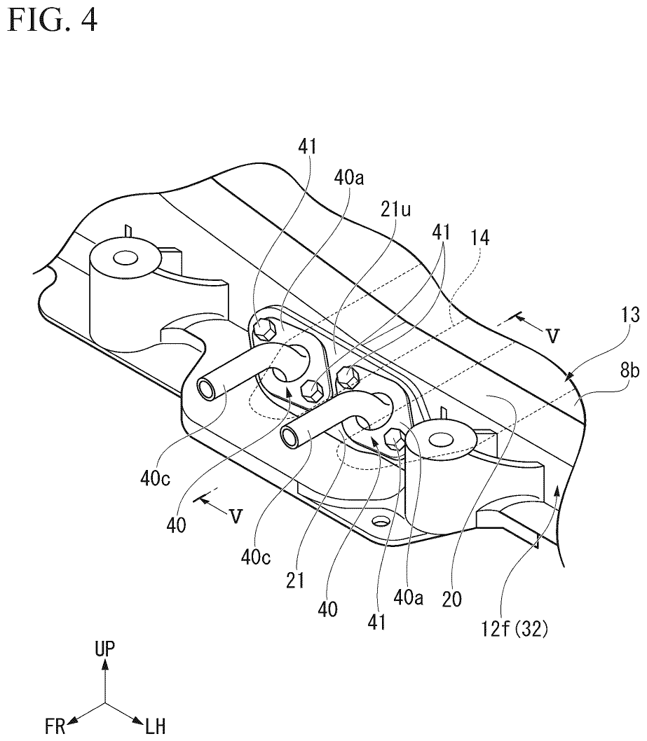

FIG. 4 is an enlarged view of a portion IV of the battery storage case 10 in FIG. 2 and FIG. 5 is a cross-sectional view of the battery storage case 10 along line V-V of FIG. 4.

The first cross member 12f has an upper upright portion 20 that rises upward from the upper surface of the front edge of the bottom wall member 13. The upper upright portion 20 is formed on a closed cross section having a vertically long rectangular shape. The closed cross section of the upper upright portion 20 extends in approximately the vehicle width direction. In the first cross member 12f, both ends of the upper upright portion 20 in the extending direction are connected in the vicinity of the front ends of the left and right main frame members 11. Accurately, both ends of the upper upright portion 20 of the first cross member 12f are connected to a position on a rear side of the front end near the front end of the main frame member 11 (a position on the inward side of the end of the second frame in the extending direction).

The first cross member 12f includes a pair of inclined block portions 21 that bulge forward from a front surface (a front side surface) of the upper upright portion 20. One inclined block portion 21 is arranged at approximately the center of the left half region of the upper upright portion 20 in the extending direction and the other inclined block portion 21 is arranged at approximately the center of the right half region of the upper upright portion 20 in the extending direction.

A surface of each inclined block portion 21 directed in a forward-upward direction (hereinafter referred to as an “upper surface 21u”) is inclined in a forward-downward direction so that a distance from the upper upright portion 20 gradually increases from the top to the bottom. Moreover, as shown in FIG. 5, the lower surfaces 201 and 211 of the upper upright portion 20 and the inclined block portion 21 are in contact with the upper surface of the front edge of the bottom wall member 13 (the base wall 8b) and are fixed to the bottom wall member 13 in a liquid-tight state in that state.

In the present embodiment, the upper upright portion 20 extending in the vehicle width direction and the inclined block portion 21 connected to the front side of the upper upright portion 20 are integrally formed by casting or the like. The upper upright portion 20 and the inclined block portion 21 are configured as an integrally molded part.

Moreover, the battery storage case 10 includes adapter parts 40 for supplying and discharging the coolant to and from the coolant passage 14. There are one adapter part 40 for inlet and one adapter part 40 for outlet for each of the left and right coolant passages 14. These adapter parts 40 are attached to the upper surfaces 21u of the inclined block portions 21 of the first cross member 12f, as will be described in detail below.

In each inclined block portion 21 of the first cross member 12f, a pair of through holes 22 that penetrate the upper surface 21u of the inclined block portion 21 and the lower surfaces 211 and 201 of the inclined block portion 21 and the upper upright portion 20 are formed. The pair of through holes 22 are formed side by side in the vehicle width direction. A lower region of each through hole 22 is formed across the lower surface 211 of the inclined block portion 21 and the lower surface 201 of the upper upright portion 20. Moreover, a corresponding adapter part 40 is attached to the upper portion of each through hole 22.

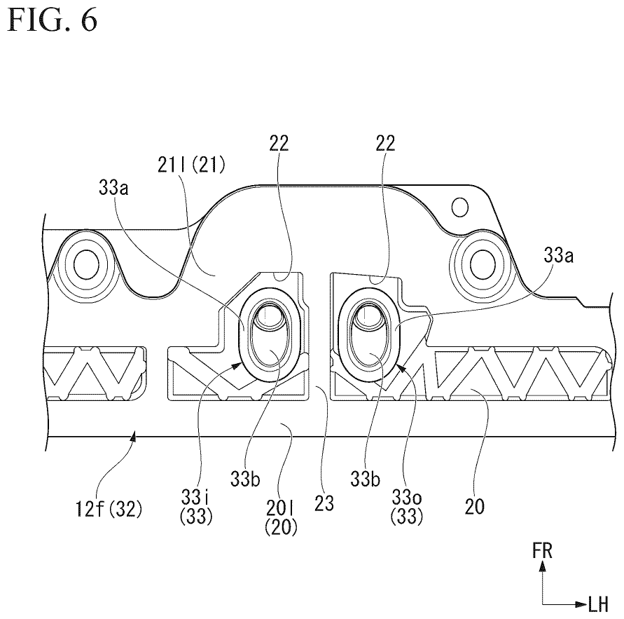

FIG. 6 is a bottom view of the front edge of the battery storage case 10 with the bottom wall member 13 removed.

As shown in FIG. 6, the pair of through holes 22 formed across the inclined block portion 21 and the upper upright portion 20 adjacent thereto are partitioned by a reinforcing rib 23 extending in the up-down direction within the first cross member 12f (inside the outer frame 32). The reinforcing rib 23 extends from the lower surfaces 211 and 201 of the inclined block portion 21 and the upper upright portion 20 in the up-down direction to reach the upper surface of the inclined block portion 21. The lower surface of the reinforcing rib 23 abuts against the upper surface of the front edge of the bottom wall member 13 in a state in which the inclined block portion 21 and the upper upright portion 20 are fixed to the front edge of the bottom wall member 13.

As shown in FIG. 5, an inlet-side joint part 33i and an outlet-side joint part 33o connected to the two coolant passages 14 within the bottom wall member 13 are attached to the front edge of the bottom wall member 13. The inlet-side joint part 33i and the outlet-side joint part 33o have shapes similar to each other. Hereinafter, when there is no need to distinguish the inlet-side joint part 33i and the outlet-side joint part 33o, they will be referred to as a joint part 33.

The inlet and outlet of the coolant in each of the two coolant passages 14 are arranged adjacent to each other in the vehicle width direction at the front edge of the bottom wall member 13. These inlet and outlet are formed at positions corresponding to the above-described pair of through holes 22 in the first cross member 12f. The inlet-side joint part 33i is liquid-tightly connected to the inlet and the outlet-side joint part 33o is similarly liquid-tightly connected to the outlet.

As shown in FIG. 5, each joint part 33 includes an annular base part 33a connected and fixed to a corresponding inlet 14i or a corresponding outlet 140 and a connection tube 33b protruding obliquely in a forward-upward direction from the base part 33a. When the first cross member 12f is attached to the upper surface of the front edge of the bottom wall member 13, the connection tube 33b of each joint part 33 is inserted into the corresponding through hole 22 on the first cross member 12f side from below. At this time, the tip of the connection tube 33b protrudes obliquely upward toward the upper surface 21u of the inclined block portion 21 inside the through hole 22.

Moreover, as shown in FIGS. 4 and 5, the adapter part 40 for supplying and discharging the coolant to and from the coolant passage 14 includes a fixed flange 40a overlapping the upper surface 21u of the inclined block portion 21 of the first cross member 12f, a fitting tube 40b that protrudes to the center of the back side of the fixed flange 40a and is fitted into the through hole 22 of the inclined block portion 21 and the connection tube 33b of the joint part 33, and a pipe connection portion 40c that protrudes to the center of the front side of the fixed flange 40a and is connected to an external coolant circulation circuit (not shown). Passage holes that communicate with the pipe connection portion 40c, the fixed flange 40a, and the fitting tube 40b are formed in the adapter part 40.

The adapter part 40 is fixed to the inclined block portion 21 by bolts 41 in a state in which the fixed flange 40a is overlapped on the upper surface 21u of the inclined block portion 21. An annular first seal member 42 is interposed at a butt joint between the fixed flange 40a and the upper surface 21u of the inclined block portion 21 to seal a gap therebetween.

Moreover, an annular groove 43 is formed on an outer circumferential surface of a portion fitted into an inner circumferential surface of the connection tube 33b of the joint part 33 in the fitting tube 40b. An annular second seal member 44 is stored in this annular groove 43. The second seal member 44 abuts against an inner circumferential surface of the connection tube 33b while being stored in the annular groove 43, thereby sealing a gap between the fitting tube 40b and the connection tube 33b of the joint part 33. Because the second seal member 44 is stored within the annular groove 43 on the outer circumference of the fitting tube 40b, it is prevented from falling off the adapter part 40 even if the adapter part 40 and the joint part 33 move relatively in the axial direction during assembly or the like.

The pipe connection portion 40c protrudes obliquely upward and forward from the fixed flange 40a and then bends toward the front of the vehicle and the front end side has at an approximately horizontal posture. In the pipe connection portion 40c, a connection pipe of an external coolant circulation circuit can be connected to the front end with an approximately horizontal posture.

A procedure for assembling the battery storage case 10 described above will now be described.

Initially, as shown in FIG. 3, four joint parts 33 are attached to the front edge of the bottom wall member 13, which defines the two coolant passages 14 by the base wall 8b and the flow path forming wall 8f. In this state, the connection tubes 33b of each of the four joint parts 33 protrude in a forward-upward direction from the upper surface of the front edge of the bottom wall member 13.

Moreover, the outer frame 32 is previously assembled as a single unit and two corresponding adapter parts 40 are bolted to each inclined block portion 21 of the first cross member 12f of the front side. At this time, an annular first seal member 42 is interposed between the fixed flange 40a of each adapter part 40 and the upper surface 21u of the inclined block portion 21. Moreover, an annular second seal member 44 is attached to an annular groove 43 of the fitting tube 40b.

Next, in this state, the outer frame 32 is assembled to the upper part of the bottom wall member 13. At this time, the outer frame 32 is aligned with the bottom wall member 13 so that the first cross member 12f of the outer frame 32 is along the front edge of the bottom wall member 13 and the left and right main frame members 11 are along the left and right side edges of the bottom wall member 13. At this time, in the adapter part 40 attached to the through holes 22 of each inclined block portion 21, their fitting tube 40b is fitted into the inner circumferential surface of the connection tube 33b of the corresponding joint part 33 inside the through holes 22. Thereby, the first cross member 12f is accurately aligned with the front edge of the bottom wall member 13.

Thereafter, the outer frame 32 is fixed to the bottom wall member 13 by bolting or the like.

As described above, the battery storage case 10 of the present embodiment includes the upper upright portion 20 and the inclined block portion 21 connected to the front side surface of the upper upright portion 20 in a part (the first cross member 12f) of the outer frame 32, wherein the through hole 22 penetrating in the up-down direction is formed in the inclined block portion 21. Also, the joint part 33 and the adapter part 40 connected to the coolant passage 14 within the bottom wall member 13 are connected in a fitted state inside the through hole 22. Therefore, in this configuration, the through hole 22 in which a connection portion of the joint part 33 and the adapter part 40 is arranged penetrates a part of the outer frame 32 obliquely. However, because a main portion of the through hole 22 is formed in the inclined block portion 21 connected to the upper upright portion 20, the through hole 22 does not significantly reduce the rigidity of the outer frame 32.

Moreover, in the battery storage case 10 of the present embodiment, the inclined block portion 21 is connected to the upper upright portion 20 of the outer frame 32, and its lower surface side is in contact with the upper surface of the outer edge of the bottom wall member 13. Therefore, the inclined block portion 21 is supported with high rigidity according to the upper upright portion 20 and the bottom wall member 13.

Therefore, even if the through holes 22 are formed in the outer frame 32, the battery storage case 10 of the present embodiment can maintain high rigidity of the outer frame 32.

Moreover, in the present embodiment, the connection tube 33b of the joint part 33 on the bottom wall member 13 side is inclined and protruded in a forward-upward direction. Therefore, the coolant supplied to and discharged from the coolant passage 14 of the bottom wall member 13 flows through a passage (the connection tube 33b) that is inclined at an obtuse angle. As a result, the pressure loss of the coolant is reduced compared to when the coolant is supplied to and discharged from the coolant passage 14 through a passage that is bent at an approximately right angle. Therefore, the energy loss can be suppressed when the coolant flows through the coolant passage 14.

Therefore, when the battery storage case 10 of the present embodiment is employed, it is possible to reduce the pressure loss of the coolant supplied to and discharged from the coolant passage 14 while suppressing the decrease in rigidity of the outer frame 32. As a result, it is possible to reduce power loss and make the entire battery storage case smaller and lighter, thereby improving the energy efficiency of the vehicle.

Moreover, in the battery storage case 10 of the present embodiment, the joint part 33 having the connection tube 33b is attached to the bottom wall member 13, and the adapter part 40 is connected to the connection tube 33b of the joint part 33 inside the through hole 22 in a fitted state. Therefore, when the outer frame 32 is assembled to the bottom wall member 13, the adapter part 40 is attached in advance to the through hole 22 of the outer frame 32, and in this state, the adapter part 40 can be fitted into the connection tube 33b of the joint part 33 on the bottom wall member 13 side, thereby aligning the outer frame 32 with the bottom wall member 13.

Therefore, when the battery storage case 10 of the present embodiment is employed, the assembly work of the outer frame 32 to the bottom wall member 13 can be easily performed.

Moreover, in the battery storage case 10 of the present embodiment, the inclined block portion 21 is connected to a side surface (a front side surface) of the upper upright portion 20 away from the module placement portion 19 of the bottom wall member 13. Therefore, the inclined block portion 21 can ensure the arrangement space for the supply/discharge passage of the coolant without compressing a mounting space for the battery module 7 on the bottom wall member 13.

Furthermore, in the battery storage case 10 of the present embodiment, the end of the first cross member 12f having the upper upright portion 20 and the inclined block portion 21 in the extending direction is connected at a position (a rear position) on the inward side of the end (the front end) of the main frame member 11 in the extending direction in the upper upright portion 20. Therefore, when an impact load is input to the main frame member 11 from the side of the vehicle, the load is reliably absorbed by the first cross member 12f at a position (a rear position) on the inward side of the end (the front end) of the main frame member 11 in the extending direction. At this time, because the first cross member 12f is connected to the main frame member 11 at the upper upright portion 20, the inclined block portion 21 is located at a position away from a load transmission axis of the upper upright portion 20 (a load transmission path in the vehicle width direction).

Therefore, if the battery storage case 10 of the present embodiment is employed, when an impact load is input, the load is less likely to be transmitted around the supply/discharge part of the coolant passage 14 (the adapter part 40 and the joint part 33).

Moreover, in the battery storage case 10 of the present embodiment, the upper upright portion 20 extends in the vehicle width direction (the first direction), and the inclined block portion 21 to which the adapter part 40 is attached is connected only to a part of the upper upright portion 20 in the extending direction. Therefore, when this configuration is employed, it is possible to supply and discharge the coolant to and from the coolant passage 14 of the bottom wall member 13 as desired, while avoiding an increase in size and weight of the first cross member 12f (the outer frame 32).

Moreover, in the battery storage case 10 of the present embodiment, the upper upright portion 20 and the inclined block portion 21 of the first cross member 12f are configured as an integrally molded part by casting or the like. Therefore, when this configuration is employed, the upper upright portion 20 and the inclined block portion 21 can be easily formed, and the overall rigidity and strength can be maintained higher.

Furthermore, in the battery storage case 10 of the present embodiment, the joint part 33 includes the inlet-side joint part 33i and the outlet-side joint part 33o, and the inlet-side joint part 33i and the outlet-side joint part 33o are attached adjacent to each other in the vehicle width direction on the bottom wall member 13. Also, the through hole 22 into which the connection tube 33b of the inlet-side joint part 33i is inserted and the through hole 22 into which the connection tube 33b of the outlet-side joint part 33o is inserted are partitioned by a reinforcing rib 23 extending inside the first cross member 12f (the outer frame 32), and a lower end of the reinforcing rib 23 comes into contact with the bottom wall member 13.

Thus, when this configuration is employed, the rigidity of the first cross member 12f (the outer frame 32) in the vicinity of the through hole 22 can be efficiently increased by the reinforcing rib 23. Furthermore, in this configuration, because the reinforcing rib 23 extends vertically inside the first cross member 12f and has its lower end in contact with the bottom wall member 13, the heat of the battery module 7 transmitted to the bottom wall member 13 can be efficiently discharged to the outward side through the reinforcing rib 23.

Therefore, when the battery storage case 10 of the present embodiment is employed, it is possible to further increase the rigidity in the vicinity of the through hole 22 of the first cross member 12f (the outer frame 32) and further improve the heat dissipation properties of the battery module 7.

The present invention is not limited to the above-described embodiment, and various design modifications are possible without departing from the scope and spirit of the present invention. For example, in the above-described embodiment, the upper upright portion 20 and the inclined block portion 21 are provided on the first cross member 12f on the vehicle front side of the outer frame 32. However, the upper upright portion 20 and the inclined block portion 21 may be provided on the second cross member 12s on the rear side. Moreover, the upper upright portion 20 and the inclined block portion 21 may be provided on the main frame member 11 on the side of the vehicle.

Furthermore, in the above-described embodiment, the inclined block portion 21 is connected to only a part of the upper upright portion 20 in the extending direction. However, the inclined block portion 21 may be connected to the upper upright portion 20 to extend over the entire range of the upper upright portion 20 in the extending direction.

Moreover, in the above-described embodiment, the adapter part 40 that is fitted and connected to the inlet-side joint part 33i and the adapter part 40 that is connected to the outlet-side joint part 33o are each configured as separate parts. However, these adapter parts 40 may also be configured as an integrated part.

### BRIEF DESCRIPTION OF THE REFERENCE SYMBOLS

7 Battery module
10 Battery storage case
11 Main frame member (second frame)
12f First cross member (first frame)
13 Bottom wall member
14 Coolant passage
19 Module placement portion
20 Upper upright portion
21 Inclined block portion
22 Through hole
23 Reinforcing rib
32 Outer frame
33 Joint part
33b Connection tube
33i Inlet-side joint part
33o Outlet-side joint part
40 Adapter part

What is claimed is:

1. A battery storage case comprising:
a bottom wall member having a module placement portion on which a battery module is placed and having a coolant passage built thereinto;
an outer frame connected to an outer edge of the bottom wall member; and
an adapter part connected to the coolant passage and configured to supply and discharge a coolant to and from the coolant passage,
wherein the outer frame has
an upper upright portion configured to rise upward from an upper surface of the bottom wall member; and
an inclined block portion connected to a side surface of the upper upright portion and configured to bulge downward from an upper portion so that a distance from the upper upright portion increases and have a lower surface in contact with the bottom wall member,
wherein a through hole which passes therethrough in an up-down direction and to which the adapter part is connected on an upper portion side is provided on the inclined block portion,
wherein a joint part having one end connected to the coolant passage and the other end on which a connection tube is formed is attached in a region where the upper upright portion of the bottom wall member and the inclined block portion are placed,
wherein the connection tube protrudes obliquely upward from the bottom wall member toward the upper surface of the inclined block portion inside the through hole, and
wherein the adapter part is connected to the connection tube of the joint part in a fitted state inside the through hole.

2. The battery storage case according to claim 1,
wherein the outer frame includes
a first frame having the upper upright portion and the inclined block portion and extending in a first direction intersecting a vertical direction; and
a pair of second frames extending in a second direction intersecting the first direction and the vertical direction and connected to both ends of the first frame in an extending direction, and
wherein the end of the first frame in the extending direction is connected to the upper upright portion at a position on an inward side of an end of the second frame in the extending direction.

3. The battery storage case according to claim 1,
wherein the upper upright portion extends in a direction intersecting a vertical direction, and
wherein the inclined block portion is connected to only a part of the upper upright portion in an extending direction.

4. The battery storage case according to claim 1, wherein the upper upright portion and the inclined block portion are formed as a single molded part.

5. The battery storage case according to claim 1,
wherein the joint part includes an inlet-side joint part connected to an inlet of the coolant of the coolant passage and an outlet-side joint part connected to an outlet of the coolant of the coolant passage,
wherein the inlet-side joint part and the outlet-side joint part are attached mutually adjacent to the bottom wall member,
wherein the through hole into which the connection tube of each of the inlet-side joint part and the outlet-side joint part is inserted is partitioned by a reinforcing rib extending inside the outer frame in the up-down direction, and
wherein a lower end of the reinforcing rib is in contact with the bottom wall member.
